(19) United States
(12) Patent Application Publication
(10) Pub. No.: US 2017/0163952 A1
(43) Pub. Date: Jun. 8, 2017

(54) METHOD AND ELECTRONIC DEVICE FOR CALIBRATING IMAGE WHITE BALANCE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Wenping WANG, Beijing (CN)

(21) Appl. No.: 15/242,411

(22) Filed: Aug. 19, 2016

Related U.S. Application Data
(63) Continuation of application No. PCT/CN2016/088965, filed on Jul. 6, 2016.

(30) Foreign Application Priority Data
Dec. 8, 2015 (CN) 201510896666.4

(51) Int. Cl. H04N 9/73; H04N 1/60; G06T 7/00

(52) U.S. Cl. CPC H04N 9/735; G06T 7/0081; H04N 1/6027

(57) ABSTRACT

The present disclosure discloses a method and an electronic device for calibrating image white balance. The method includes: dividing a preview image captured by a camera into a preset number of and images; calculating a white balance calibration parameter corresponding to each of the grid images according to color ratio data of each of pixel points in each a the grid images, where the color ratio data includes a red to green ratio R/G and a blue to green ratio B/G; and calibrating white balance of each of the grid images according to the white balance calibration parameter.

### CROSS-REFERENCE TO RELATED APPLICATIONS

The present application is a continuation application of a PCT application No. PCT/CN2016/088965 filed on Jul. 6, 2016 and claims the priority to Chinese Patent Application No. 201510896666.4. titled “METHOD AND DEVICE FOR CALIBRATING IMAGE WHITE BALANCE”, filed to the State Intellectual Property Office of The P.R.C on Dec. 8, 2015, which are herein incorporated by reference in its entirety.

### TECHNICAL FIELD

The present disclosure relates to technologies of image processing, for example, relates to a method and an electronic device for calibrating image white balance.

### BACKGROUND

In an image capturing process, since images captured under different colors of light rays are different in colors. Generally, in the capturing process, a white balance calibration is performed on a camera according to a current light source to obtain a corresponding parameter, and the image, which is captured under the light source, of a white object, is made to appear white based on the parameter.

Generally, for the white balance calibration, the image captured b the camera is segmented into 3072 areas, and a R/G (Red/Green) and a B/G (Blue/Green) of each pixel point in each area are calculated. Then the R/Gs and the B/Gs of the pixel points belonging to the same area are averaged to obtain a R/G and a B/G of this area, and the coincident light source is selected from a standard grey-band diagram according to the R/G and the R/G of this area. Then a light source coincident to the whole image is selected from the standard grey-band diagram by means of a manner of performing weighted average on respective areas, and finally the captured image is subject to white balance calibration according to a white balance calibration parameter corresponding to this light source. FIG. 1 shows a schematic diagram of a standard grey-band diagram. As shown in FIG. 1, coordinate ranges of the R/Gs and the B/Gs corresponding to eight standard light sources (D75, D65, D50, CW, TL84, A and H light sources) are particularly defined in the standard grey-band diagram.

In a process of implementing the present application, the inventor has found that the white balance calibration parameter obtained by employing the above method is generally suitable for a case where a captured object is under a monochromatic light source. When the captured object is under two or more kinds of light sources, the color of the image, captured by employing the white balance calibration parameter obtained by the above overall calculating method, is severely distorted.

### SUMMARY

The present disclosure provides a method and a device for calibrating image white balance to accurately and effectively calibrate white balance of an image captured under mixed light sources.

In a first aspect, an embodiment of the present disclosure provides a method for calibrating image white balance including:

dividing a preview image captured by a camera into a preset number of grid images;

calculating a white balance calibration parameter corresponding to each of the grid images according to color ratio data of each of pixel points in each of the grid images; and

calibrating white balance of each of the grid images according to the white balance calibration parameter.

In a second aspect, an embodiment of the present disclosure further provides an electronic device for calibrating image white balance, including: at least one processor; and a memory communicably connected with the at least one processor for storing instructions executable by the at least one processor, wherein execution of the instructions by the at least one processor causes the at least one processor to:

divide a preview image into a preset number of grid images;

calculate a white balance calibration parameter corresponding to each of the grid images according to color ratio data of each of pixel points in each of the grid images, where the color ratio data comprises a red to green ratio R/G and a blue to green ratio B/G; and

according to the white balance calibration parameter; calibrate white balance of each of the grid images.

In a third aspect, an embodiment of the present disclosure provides a non-transitory computer-readable storage medium storing executable instructions that, when executed by an electronic device, cause the electronic device to:

divide a preview image captured by a camera into a preset number of grid images;

calculate a white balance calibration parameter corresponding to each of the grid images according to color ratio data of each of pixel points in each of the grid images; and

calibrate white balance of each of the grid images according to the white balance calibration parameter.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a standard (PRIOR ART) grey-band diagram according to the related art;

FIG. 2 is a flow diagram of a method for calibrating image white balance according to some embodiments of the present disclosure;

FIG. 3 is a flow diagram of a method for calibrating image white balance according to some embodiments of the present disclosure;

FIG. 4 is a flow diagram of a method for calibrating image white balance according to some embodiments of the present disclosure;

FIG. 5 is a structural diagram of an electronic device for calibrating image white balance according to some embodiments of the present disclosure; and

FIG. 6 is a schematic diagram of a hardware structure of an electronic device according to an embodiment of the present disclosure.

### DETAILED DESCRIPTION

The present disclosure will be further described in detail below in conjunction with accompanying drawings and embodiments. It should be understood that the embodiments described herein are merely used for explaining the present disclosure, but not limiting the present disclosure. In addition it is also noted that, for easy of description, relevant structures, rather than all structures, related to the present disclosure are shown in the accompanying drawings.

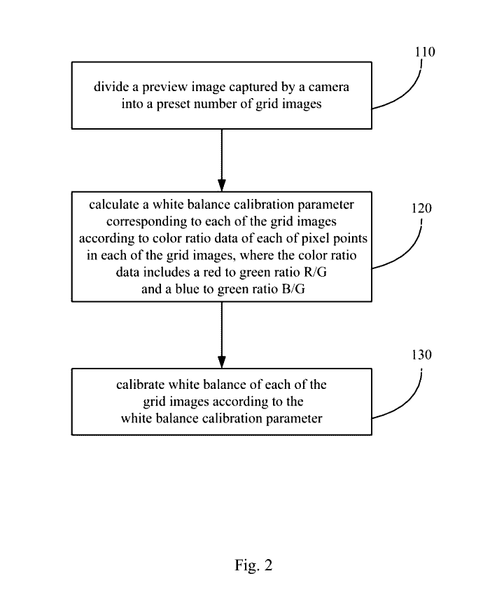

FIG. 2 is a flow diagram of a method for calibrating image white balance according to some embodiments of the present disclosure. The present embodiment may be suitable for a case where white balance of a captured image is calibrated. The method of this embodiment may be performed by an image white balance calibration apparatus. The apparatus may be implemented in a hardware and/or software manner, and may be generally integrated into a capturing device (for example, a digital camera, a mobile phone or a tablet personal computer and the like) provided with a camera. The method includes: a step 110, a step 120 and a step 130.

In Step 110, a preview image captured by a camera is divided into grid images.

In the present embodiment, an image white balance calibration is performed after the camera of the capturing device is turned on and captures the preview image. The preview image particularly refers to an image captured by the camera under a turning-on state. Generally, after hardware of the camera is uniquely determined, a size of the preview image which may be captured by the camera is uniquely determined as well.

After the preview image captured by the camera is obtained, the preview image is firstly divided into grid images. A particular grid dividing manner may be preset according to actual conditions, example, the minimal grid size ma be pre-defined, and then grids are correspondingly divided according to the size of the preview image; the number of grids required to be divided may be predefined, and then grids are correspondingly divided based on the size of the capturing preview image.

Optionally, for ease of subsequent calculation, the preview image captured by the camera may be divided into 16×12 grid images.

In Step 120, a white balance calibration parameter corresponding to each of the grid images according to color ratio data of each of pixel points in the grid images is calculated, where the color ratio data includes a red to green ratio R/G and a blue to green ratio B/G.

Generally, each pixel point in the image has a R (Red) value, a B (Blue) value and a G (Green) value. The red to green ratio R/G and the blue to green ratio B/G of each pixel point may be obtained by reading the R, B and G values of each pixel point and performing simple calculation.

In this embodiment, it is inventively proposed that white balance calibration parameter of each grid image is determined by calculating color ratio data of each pixel point in each grid image. By means of the above setting, the image white balance calibration process does not perform unified calibration on the whole image, but divides the image into grid images (that is, a grid image is a unit) and then perform white balance calibration on each grid image. By means of the above setting, the technical problem of severe distortion of white balance calibration of the related art under multiple light sources may be solved.

In Step 130. Calibrating white balance of each of the grid images is performed according to the white balance calibration parameter.

In this embodiment, the white balance of each of grid images is calibrated according to the corresponding white balance calibration parameter.

By dividing a preview image captured by a camera into a preset number of grid images, calculating a white balance calibration parameter corresponding to each of the grid images according to color ratio data of each of pixel points in each grid image, and calibrating white balance of each of the grid images according to the white balance calibration parameter, a technical solution of this embodiment realizes white balance calibration on each of the grid images under mixed light sources, avoids a phenomenon of relatively severe distortion of color of the image calibrated by an existing white balance calibration technology under mixed light sources, and achieves a technical effect of better reducing white balance of the image captured under the mixed light source.

On the basis of the above embodiment, before the step 110, the image white balance calibration method may further include:

acquiring standard images captured under each of standard light sources in a standard grey-band diagram; and

determining a white balance calibration parameter corresponding to each of the standard light sources, based on a standard single light white balance calibration strategy, according to each of the standard images.

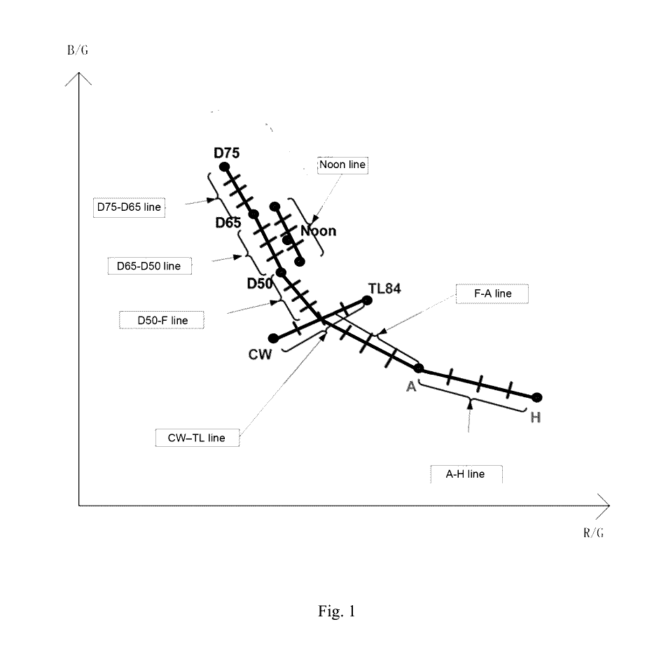

Before a white balance parameter under mixed light sources is obtained, corresponding standard images may be captured based on eight standard light sources in the standard grey-band diagram as shown in FIG. 1 firstly, and then calibrated according to white balance of respective captured standard images respectively corresponding to respective standard light sources, so as to obtain a white balance calibration parameter corresponding to each of the standard light sources.

Optionally, a certain parameter may be added, on the basis of the white balance calibration parameter that A light and H light are calibrated, such that it becomes a white balance calibration parameter corresponding to a warm tone.

A reason for such a setting is that: due to various device errors, even if two cameras are same in models and parameters, there is no guarantee that parameters of the captured image are completely consistent. Therefore, if different capturing devices all use same white balance calibration parameters corresponding to each of the standard light sources, distortion may be certainly caused. To increase the final image white balance calibration effect, there is a need for determining white balance calibration parameters corresponding to different standard light sources based on the capturing devices being used.

On the basis of the above embodiments, the image white balance calibration method may further include:

If a photosensitive member in the camera determines that the preview image currently captured by the camera changes, re-calibrating white balance of each of the grid images according to the updated preview image.

When the photosensitive member in the camera senses that the capturing preview image currently captured by the camera changes, particularly, when the photosensitive member in the camera senses that light rays entering the photosensitive member change, white balance of each of the grid images is immediately re-calibrated according to the updated capturing preview image.

The benefit of the above setting is that: when the camera has not captured the image and searches a suitable scene from a field of view, corresponding white balance calibration parameters may be formed once the scene is found.

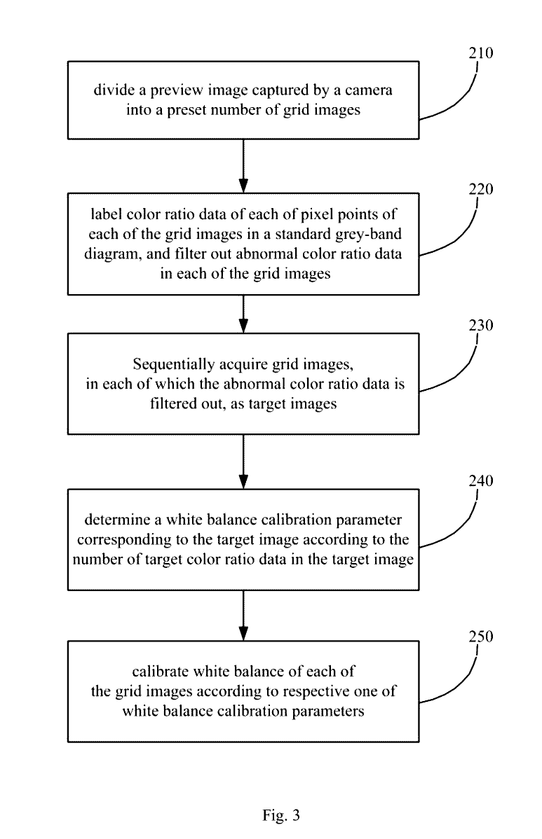

FIG. 3 is a flow diagram of a method for calibrating image white balance according to some embodiments of the present disclosure. The method of this embodiment includes a step 210 to a step 250.

In Step 210, a preview image captured by a camera is divided into a preset number of grid images.

In Step 220, color ratio data of each of pixel points corresponding to each of the grid images is labeled in a standard grey-hand diagram, and abnormal color ratio data included in each of the grid images is filtered out.

In this embodiment, a color ratio data range corresponding to each of standard light sources is particularly identified in the standard grey-band diagram (as shown in FIG. 1), and different standard light sources correspond to different white balance calibration parameters.

In some embodiments, the step 220 includes:

if one color ratio data is not within the color ratio data range determined by the standard grey-band diagram, this color ratio data is determined to be an abnormal color ratio data.

Particularly, each grid image includes multiple pixel points, each pixel point has corresponding color ratio data. If the color ratio data of a certain pixel point in the grid images is not within the color ratio data range determined by the standard grey-band diagram, the color ratio data of the pixel point is determined to be abnormal color ratio data. By deleting the above abnormal color ratio data, misjudgment of extreme colors on the standard light sources may be avoided.

In some embodiments, the step 220 may further include:

after the color ratio data of each of pixel points are labeled in the standard grey-band diagram, a first point set is constructed from color ratio data that a relative distance is smaller than a first threshold;

using the first point set, in which the number of color ratio data is greater than a second threshold, as an effective point set; and

the color ratio data excluding the effective point set in the color ratio data of each of pixel points corresponding to each of the grid images is determined to be the abnormal color ratio data.

In some embodiments, after the color ratio data of each pixel point is labeled in the standard grey-band diagram, generally color ratio data of most pixel points is very close, and may be within a range determined by one standard light source or two standard light sources in a grey band. If in such case and the color ratio data of several pixel points greatly deviates from the range determined by the standard light source to which most pixel points belong in the grey band, the color ratio data of these most pixel points may construct the first point set.

The first threshold and the second threshold may be preset according to an actual demand. For example, the pixel points that a relative distance is smaller than 4 construct the first point set; and when the number of the pixel points in the first point set exceeds ½ of the total number of the pixel points in the image, the first point set serves as an effective point set. After the effective point set is determined, the color ratio data, except for the effective point set, corresponding to each of the grid images may be determined to be the abnormal color ratio data.

A reason for such setting is that: pure-color objects of non-extreme colors may exist in a whole picture, the pure-color objects may fall in the standard grey-band diagram, and this pure-color object possibly occupies one or more grid images (that is, no objects of other colors in the one or more rid images), so there is a certain distance between a labeling result of pixel points of these grid images in the standard grey-band diagram and a labeling result of most pixel points in the whole picture in the standard grey-band diagram. The standard light source light is certainly wrong, if it is determined according to these grid images. The above mistake may be avoided by deleting the above abnormal color ratio data.

In Step 230, grid images, in each of which the abnormal color ratio data is filtered out, are sequentially acquired as target images.

Each grid image that the abnormal color ratio data is filtered out is used as the target image, and a white balance calibration parameter corresponding to the target image is determined.

In Step 240, a white balance calibration parameter corresponding to the target image is determined according to the number of target color ratio data included in the target image, where the target color ratio data refers to color ratio data except for the abnormal color ratio data.

In some embodiments, the white balance calibration parameter corresponding to the target image may be determined according to the difference (zero or at least one) in the number of the target color ratio data included in the target image.

In Step 250, white balance of each of the grid images is calculated according to the white balance calibration parameter.

By filtering out the abnormal color ratio data included in each of the grid images firstly and then determining the white balance calibration parameter corresponding to the grid image that the abnormal color ratio data is filtered out, a technical solution of this embodiment avoids misjudgment on the standard light sources when the grid images include pure-color (extreme color or non-extreme color) objects, and further improves the image white balance calibration effect.

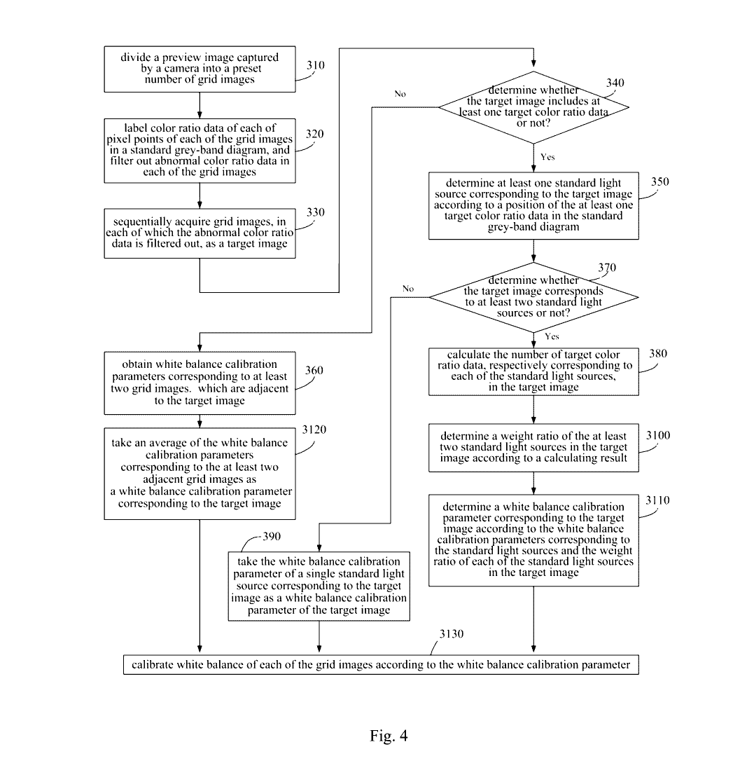

FIG. 4 is a flow diagram of a method for calibrating image white balance according to some embodiments of the present disclosure, and this embodiment is optimized on the basis of the above embodiments. The method of this embodiment includes:

In Step 310, a preview image captured by a camera is divided into a preset number of grid images.

In Step 320, color ratio data of each of pixel points of each of the grid images is labeled in a standard grey-band diagram, and abnormal color ratio data included in each of the grid images is filtered out.

In Step 330, grid images that the abnormal color ratio data is filtered out is sequentially acquired as target images.

In Step 340, it is determined whether each of target images includes at least one target color ratio data? If a target images includes at least one target color ratio data, a step 350 is executed; otherwise, a step 360 is executed.

Optionally, firstly determining whether the target image includes one or more target color ratio data or not, where the target color ratio data refers to color ratio data except for the abnormal color ratio data.

In Step 350, at least one standard light source corresponding to the target image is determined according to a position of the target color ratio data in the standard grey-band diagram, and then a step 370 is executed.

In Step 360, white balance calibration parameters of at least two grid images, which are adjacent to the target image, are obtained and then a step 3120 is executed.

In this embodiment, if the target image, includes no target color ratio data, the white balance calibration parameter corresponding to the target image cannot he directly determined according to the target image, therefore, the white balance calibration parameter of the target image may be determined according to the white balance calibration parameters of one or more neighborhood grid images adjacent to the target image.

In some embodiments, when a target grid is rectangular, neighborhood grid images at adjacent grid positions of the target image may be particularly upper, lower, left and right four proximate arid images of the target image. If the white balance calibration parameter of the four neighborhood grid images cannot be determined, a neighborhood may be continuously outwards expanded so as to acquire four grid images at an upper-left corner 45°, a lower-left corner 45°, an upper-right corner 45° and a lower-right corner 45° of the target image as new neighborhood grid images.

In Step 370, it is determined whether the target image corresponds to at least two standard light sources or not? If the target image corresponds to at least two standard light sources, step 380 is performed; otherwise, step 390 is performed.

In Step 380, the number of each target color ratio data, respectively corresponding to each of the standard light sources, in the target image, is calculated and then step 3100 is performed.

Following the step 370, when the target image corresponds to two or more standard light sources, numbers of target color ratio data, respectively corresponding to each of the standard light sources, in the target image are calculated. For example, the number of the color ratio data that belongs to the standard A light source in the standard grey-band diagram is 100, and the number of the color ratio data that belongs to the standard H light source in the standard grey-band diagram is 200.

In Step 390 the white balance calibration parameter of the single standard light source corresponding to the target image, is taken as a white balance calibration parameter of the target image, and then step 3130 is performed.

When the target image corresponds to one standard light source, the white balance calibration parameter corresponding to the one standard light source is used as the white balance calibration parameter corresponding to the target image.

In Step 3100, a weight ratio of the at least two standard light sources corresponding to the target image is determined according to the calculating result.

Following the step 380, optionally, for example, when the number of the color ratio data that belongs to the standard A light source in the standard grey-band diagram is 100, and the number of the color ratio data that belongs to the standard H light source in the standard grey-band diagram is 200, the weight ratio of the standard A light source to the standard H light source is 1:2.

In Step 3110, a white balance calibration parameter corresponding to the target image according to the white balance calibration parameter corresponding to each of the standard light sources and the weight ratio of each of the standard light sources in the target image is determined, and then step 3130 is performed.

Optionally, the white balance calibration parameter corresponding o the target image may be determined according to the white balance calibration parameter corresponding to each of the standard light sources and the weight ratio of each of the standard light sources in the target image. For example, following the step 3100, the color ratio data in the target image belongs to two standard light sources: the standard A light source and the standard H light source in the standard grey-band diagram. According to the above result, the above obtained weight ratio of the standard A light source to the standard H light source in the target image is 1:2, and then the white balance calibration parameters corresponding to the standard A light source and the standard H light source are multiplied by their corresponding weight ratios to obtain the white balance calibration parameter corresponding to the target image. The number of the standard light sources corresponding to the target image may be more than two. When the target image corresponds to a plurality of standard light sources, the white balance calibration parameter corresponding to the target image may also be calculated in accordance with a method that the color ratio data in the target image belongs to the two standard light sources.

In Step 3120, an average of the white balance calibration parameters corresponding to the at least two neighborhood grid images is taken as a white balance calibration parameter corresponding to the target image, and then step 3130 is performed.

Following the step 360, the white balance calibration parameter corresponding to the target image may be obtained by averaging the white balance calibration parameters corresponding to a plurality of (at least two) neighborhood grid images of the target image.

If there is only one neighborhood grid image, the white balance calibration parameter corresponding to the target image is the white balance calibration parameter corresponding to this neighborhood grid image.

In Step 3130, each of the grid images is white balanced according to the white balance calibration parameter.

By means of a technical means of determining the white balance calibration parameter corresponding to the target image by employing different strategies for different numbers of target color ratio data included in the target image and different numbers of standard light sources corresponding to the same target image, a technical solution of this embodiment may further avoid a phenomenon of relatively severe distortion of color of the image calibrated by an existing white balance calibration technology under mixed light sources, and further achieves a technical effect of better reducing white balance of the image captured under the mixed light sources.

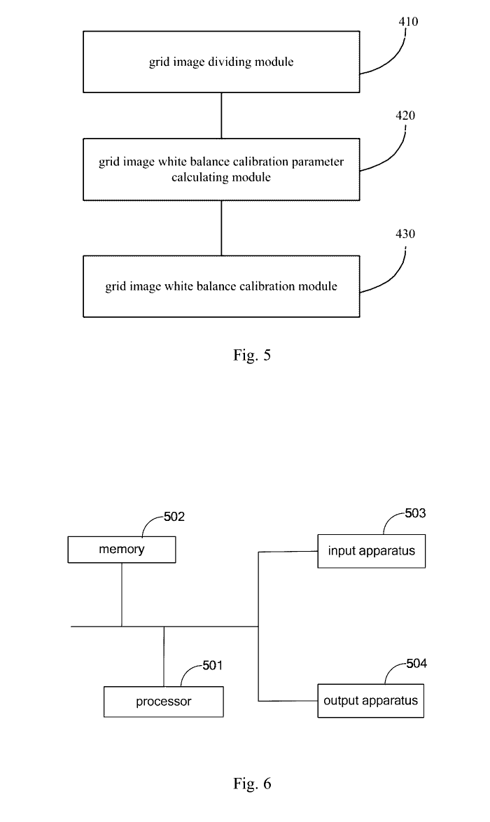

FIG. 5 is a schematic diagram of a structure of an electronic device for calibrating image white balance according to some embodiments of the present disclosure. The electronic device includes a grid image dividing module 401, a grid image white balance calibration parameter calculating module 402 and a grid image white balance calibration module 403.

The grid image dividing module 401 is configured to divide a preview image captured by a camera into a preset number of grid images.

The grid image White balance calibration parameter calculating module 402 is configured to, according to color ratio data of each of pixel points in the grid images, calculate a white balance calibration parameter corresponding to each of the grid images, where the color ratio data includes a R/G and a B/G.

The grid image white balance calibration module 403 is configured to, according to the white balance calibration parameter, calibrate white balance of each of the grid images.

By dividing the preview image captured by a camera into a preset number of grid images, calculating a white balance calibration parameter corresponding to each of the grid images according to color ratio data of each of pixel points in the grid images, and calibrating white balance of each of the grid images according to the white balance calibration parameters, a technical solution of this embodiment realizes white balance calibration on each of grid images under mixed light sources, avoids a phenomenon of relatively severe distortion of color of the image calibrated by an existing white balance calibration technology under the mixed light sources, and achieves a technical effect of well reducing white balance of the image captured under the mixed light sources.

On the basis of the above embodiments, the grid image white balance calibration parameter calculating module 402 may include: an abnormal color ratio data filtering-out submodule, a target image determining submodule and a target image white balance calibration parameter determining submodule.

The abnormal color ratio data filtering-out submodule is configured to label color ratio data of each of pixel points corresponding to each of the grid images in a standard grey-band diagram, and filter out abnormal color ratio data included in each of the grid images. The target image determining submodule is configured to sequentially obtain one grid image that the abnormal color ratio data is filtered out as a target image. The target image white balance calibration parameter determining submodule, is configured to, according to the number of target color ratio data included in the, target image, determine a white balance calibration parameter corresponding to the target image A color ratio data ranges corresponding to each of standard light sources is identified in the standard grey-bald diagram and different standard light sources correspond to different white balance calibration parameters. On the basis of the above embodiments, the abnormal color ratio data filtering-out submodule may include: a first abnormal color ratio data filtering-out unit, a first point set constructing unit, an active point set determining unit, and a second abnormal color ratio data filtering-out unit

The first abnormal color ratio data filtering-out unit is configured to, if one color ratio data is not within a color ratio data range determined by the standard grey-band diagram, determine that this color ratio datum is the abnormal color ratio datum; and

a first point set constructing unit is configured to, after the color ratio data of each of pixel points is labeled in the standard grey-band diagram, construct a first point set from the color ratio data that a relative distance is smaller than a first threshold.

The active point set determining unit is configured to use the first point set that the number of the color ratio data is greater than a second threshold as an effective point set.

The second abnormal color ratio data filtering-out unit is configured to determine that the color ratio data except for the effective point set in the color ratio data of each of pixel points corresponding to each of the grid images is abnormal color ratio data.

On the basis of the above embodiments, the target image white balance calibration parameter determining submodule may include: a standard light source determining unit and a first target image white balance calibration parameter determining unit.

The standard light source determining unit is configured to, if the target image includes at least one target color ratio data, determine at least one standard light source corresponding to the at least one target image according to positions of the at least one target color ratio data in the standard grey-band diagram.

The first target image white balance calibration parameter determining unit is configured to, according to the at least one standard light source, determine a white balance calibration parameter corresponding to the target image.

On the basis of the above embodiments, the first target image white balance calibration parameter determining unit may include: a target color ratio data number obtaining subunit, a weight ratio determining subunit and a first target image white balance calibration parameter determining subunit.

The target color ratio data number obtaining subunit is configured to, if the target image corresponds to at least two standard light sources, calculate numbers of target color ratio data, respectively corresponding to each of the standard light sources, in the target image.

The weight ratio determining subunit is configured to, according to the calculating result, determine a weight ratio of the at least two standard light sources in the target image.

The first target image white balance calibration parameter determining subunit, is configured to, according to the white balance calibration parameter corresponding to each of the standard light sources and the weight ratio of each of the standard light sources in the target image, determine a white balance calibration parameter corresponding to the target image.

On the basis of the above embodiments, the target image white balance calibration parameter determining submodule may further include: a grid image white balance calibration parameter obtaining unit, and a second target image white balance calibration parameter determining unit.

The grid image white balance calibration parameter obtaining unit is configured to if the target image includes no target color ratio data, obtain white balance calibration parameters of at least two grid images adjacent to the target image.

The second target image white balance calibration parameter determining unit is configured to use an average of the white balance calibration parameters of the at least two adjacent arid images as a white balance calibration parameter corresponding to the target image.

On the basis of the above embodiments, the apparatus may include a standard image acquiring module, which is configured to, before dividing the preview image captured by a camera into a preset number of grid images, obtain standard images when each of standard light sources in a standard grey-band diagram serves as a single light source; and

a standard light source white balance calibration parameter determining module, which is configured to, according to each of the standard images, determine a white balance calibration parameter corresponding to each of the standard light sources based on a standard single light white balance calibration strategy.

On the basis of the above embodiments, the apparatus may further include a grid image white balance re-calibration module, which is configured to, if a photosensitive member in the camera determines that a preview image currently captured by the camera changes, re-calibrate white balance of each of the grid images according to the updated preview image.

The above apparatus may perform the method provided by any of the embodiments of the present disclosure, and has corresponding functional modules, submodules, units, subunits and advantages of performing the method.

FIG. 6 is a block diagram of a hardware structure of an electronic device (for example, a feature phone) according to an embodiment of the present application. As shown in FIG. 6, the feature phone includes:

one or more processors 501 and a memory 502, where exemplified in FIG. 6 is one processor 501.

The feature phone may further include an input apparatus 503 and an output apparatus 504.

The processor 501, the memory 502, the input apparatus 503 and the output apparatus 504 in the feature phone may be connected by a bus or by any other means, and exemplified in FIG. 6 is a bus connection.

The memory 502, a nonvolatile computer readable storage medium, may be used to store a nonvolatile software program, a nonvolatile computer executable program and modules, such as program instructions/modules (for example, a grid image dividing module 401, a grid image white balance calibration parameter calculating module 402 and a grid image white balance calibration module 403 as shown in FIG. 5) corresponding to the image white balance calibration method in the embodiments of the present disclosure. The processor 501 executes various functional applications of a server and data processing by running the nonvolatile software program, the instructions and the modules which are stored in the memory 502, that is, the image white balance calibration method is realized.

The memory 502 may include a program storage area and a data storage area, where the program storage area may store an operating system, and applications required by at least one function; the data storage area may store data and the like created according to the use of the image white balance calibration method. In addition, the memory 502 may include a high-speed random access memory, and may further include a nonvolatile memory. For example, at least one magnetic disk memory device, a flash device, or other nonvolatile solid-state memory devices. In some embodiments, the memory 502 optionally includes memories remotely disposed relative to the processor 501.

The input apparatus 503 may be used to receive input digital or character information, as well as a key signal input related to user settings and function control. The output apparatus 504 may include display devices such as a display screen.

The one or more modules are stored in the memory 502, and perform the method for calibrating image white balance in any of the above method embodiments when being executed by the one or more processors 501.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile interne access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

Embodiments of the present disclosure further provide a non-transitory storage medium, which stores a computer executable instruction, where the computer executable instruction is configured to perform the image white balance calibration method in any one of the embodiments of the present disclosure.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement dose not make essential of corresponding technical solutions depart from spirits and scope of technical solutions of various embodiments.

Embodiments of the present disclosure provide a non-transitory storage medium having computer executable instructions stored thereon, the computer executable instructions are configured to perform the method for calibrating image white balance, in any embodiment of the present disclosure.

It is noted that the foregoing is merely illustrative of embodiments of the present disclosure and the applied technical principle. It will be appreciated to those skilled in the art that the present disclosure is not limited to the specific embodiments described herein. It will be apparent to those skilled in the art that various variations, rearrangement and substitutions can be made without departing from a protective scope of the present disclosure. Therefore, although the present disclosure has been described in detail in terms of the above embodiments, the present disclosure is not limited to the above embodiments, but may include more other equivalent embodiments without departing from the concept of the present disclosure, and the scope of the present disclosure is defined by the scope of the appended claims.

What is claimed is:

1. A method for calibrating image white balance, executed by an electronic device, the said method comprising:
dividing a preview image captured by a camera into a preset number of grid images;
calculating a white balance calibration parameter corresponding to each of the grid images according to color ratio data of each of pixel points in each of the grid images; and
calibrating white balance of each of the grid images according to the white balance calibration parameter.

2. The method according to claim 1, wherein the color ratio data comprises a red to green ratio R/G and a blue to green ratio B/G; calculating a white balance calibration parameter corresponding to each of the grid images according to color ratio data of each of pixel points in each of the grid images comprises:
labeling the color ratio data of each of pixel points in each of the grid images in a standard grey-band diagram, and filtering out abnormal color ratio data;
sequentially acquiring grid images, in each of which the abnormal color ratio data is filtered out, as a target image; and
determining a white balance calibration parameter corresponding to the target image according to the number of target color ratio data in the target image,
wherein a color ratio data range corresponding to each of standard light sources is identified in the standard grey-band diagram, and different standard light sources correspond to different white balance calibration parameters.

3. The method according to claim 2, wherein the labeling the color ratio data of each of pixel points in each of the grid images in a standard grey-band diagram, and filtering out abnormal color ratio data comprises:
if one color ratio data is not within the color ratio data range determined by the standard grey-band diagram determining that the one color ratio data is one abnormal color ratio data;
after the color ratio data of each of pixel points are labeled in the standard grey-band diagram, constructing a first point set from color ratio data that a relative distance is smaller than a first threshold;
using the first point set that the number of the color ratio data is greater than a second threshold as an effective point set; and
determining that the color ratio data except for the effective point set in the color ratio data of each of pixel points in each of the arid images is the abnormal color ratio data.

4. The method according to claim 3, wherein determining a white balance calibration parameter corresponding to the target image according to the number of target color ratio data in the target image comprises:
if the target image comprises at least one target color ratio data, determining at least one standard light source corresponding to the target image according to a position of the at least one target color ratio datum in the standard grey-band diagram; and
determining a white balance calibration parameter corresponding to the target image according to the at least one standard light source.

5. The method according to claim 4, wherein determining a white balance calibration parameter corresponding to the target image according to the at least one standard light source comprises:
if the target image corresponds to at least two standard light sources, calculating numbers of target color ratio data, respectively corresponding to each of the standard light sources, in the target image;
determining a weight ratio of the at least two standard light sources in the target image according to a calculating result; and
determining a white balance calibration parameter corresponding to the target image according to the white balance calibration parameter corresponding to each of the standard light sources and the weight ratio of each of the standard light sources in the target image.

6. The method according to claim 3, wherein the determining a white balance calibration parameter corresponding to the target image according to the number of target color ratio data in the target image comprises:
if the target image comprises no target color ratio data, obtaining white balance calibration parameters corresponding to at least two grid images adjacent to the target image; and
using an average of the white balance calibration parameters corresponding to the at least two adjacent grid images as a white balance calibration parameter corresponding to the target image.

7. The method according to claim 1, wherein before dividing the preview image into a preset number of grid images, the method further comprises:
acquiring each standard image under each of standard light sources in the standard grey-band diagram serves; and
determining a white balance calibration parameter corresponding to each of the standard light sources based on a standard single light white balance calibration strategy according to each standard image.

8. The method according to claim 1, further comprising:
if a current preview image changes, re-calibrating white balance of each of the grid images according to the updated preview image.

9. An electronic device for calibrating image white balance, comprising: at least one processor; and a memory communicably connected with the at least one processor for storing instructions executable by the at least one processor, wherein execution of the instructions by the at least one processor causes the at least one processor to:
divide a preview image into a preset number of grid images;
calculate a white balance calibration parameter corresponding to each of the grid images according to color ratio data of each of pixel points in each of the grid images, wherein the color ratio data comprises a red to green ratio R/G and a blue to green ratio B/G; and
calibrate, according to the white balance calibration parameter, white balance of each of the grid images.

10. The electronic device according to claim 9, wherein to calibrate, according to the white balance calibration parameter, white balance of each of the grid images, execution of the instructions by the at least one processor causes the at least one processor to:
label color ratio data of each of pixel points of each of the grid images in a standard grey-band diagram, and filter out abnormal color ratio data of each of the grid images;
obtain grid images, in each of which the abnormal color ratio data is filtered out, as a target image; and
determine, according to the number of target color ratio data in the target image, a white balance calibration parameter corresponding to the target image,
wherein a color ratio data range corresponding to each of standard light sources is identified in the standard grey-band diagram, and different standard light sources correspond to different white balance calibration parameters.

11. The electronic device according to claim 10, wherein to label color ratio data of each of pixel points of each of the grid images in a standard grey-band diagram, and filter out abnormal color ratio data of each of the grid images, execution of the instructions by the at least one processor causes the at least one processor to:
if one color ratio data is not within the color ratio data range determined by the standard grey-band diagram, determine that the color ratio data is abnormal color ratio data; and
after the color ratio data of each of pixel points is labeled in the standard grey-band diagram, construct a first point set from color ratio data that a relative distance is smaller than a first threshold;
use the first point set that the number of the color ratio data is greater than a second threshold as an effective point set; and
determine that the color ratio data except for the effective point set in the color ratio data of each of pixel points of each of the grid images is abnormal color ratio data.

12. The electronic device according to claim 11, wherein to determine, according to the number of target color ratio data in the target image, a white balance calibration parameter corresponding to the target image, execution of the instructions by the at least one processor causes the at least one processor to:
if the target image comprises at least one target color ratio data, determine at least one standard light source corresponding to the target image according to a position of the target color ratio data in the standard grey-band diagram; and
determine, according to the at least one standard light source, a white balance calibration parameter corresponding to the target image.

13. The electronic device according to claim 12, wherein to determine, according to the at least one standard light source, a white balance calibration parameter corresponding to the target image, execution of the instructions by the at least one processor causes the at least one processor to:
if the target image corresponds to at least two standard light sources, calculate numbers of target color ratio data, respectively corresponding to each of the standard light sources, in the target image;
determine, according to a calculating result, a weight ratio of the at least two standard light sources in the target image; and
determine, according to the white balance calibration parameter corresponding to each of the standard light sources and the weight ratio of each of the standard light sources in the target image, a white balance calibration parameter corresponding to the target image.

14. The electronic device according to claim 11, wherein to determine, according to the number of target color ratio data in the target image, a white balance calibration parameter corresponding to the target image, execution of the instructions by the at least one processor causes the at least one processor to:
a grid image white balance calibration parameter obtaining unit, configured to, if the target image comprises no target color ratio data, obtain white balance calibration parameters corresponding to at least two grid images adjacent to the target image; and
a second target image white balance calibration parameter determining unit, configured to use an average of the white balance calibration parameters corresponding to the at least two adjacent grid images as a white balance calibration parameter corresponding to the target image.

15. The electronic device according to claim 9, execution of the instructions by the at least one processor further causes the at least one processor to:
before dividing the preview image into the preset number of grid images, obtain standard images under each of standard light sources in the standard grey-band diagram; and
determine, according to each of the standard images, a white balance calibration parameter corresponding to each of the standard light sources based on a standard single light white balance calibration strategy.

16. The electronic device according to claim 9, execution of the instructions by the at least one processor causes the at least one processor to: if a current preview image changes, re-calibrate white balance of each of the grid images according to the updated capturing preview image.

17. A non-transitory computer-readable storage medium storing executable instructions that, when executed by an electronic device, cause the electronic device to:
divide a preview image captured by a camera into a preset number of grid images;
calculate a white balance calibration parameter corresponding to each of the grid images according to color ratio data of each of pixel points in each of the grid images; and
calibrate white balance of each of the and images according to the white balance calibration parameter.

18. The non-transitory computer-readable storage medium according to claim 17, wherein the color ratio data comprises a red to green ratio R/G and a blue to green ratio B/G; to calculate white balance calibration parameter corresponding to each of the grid images according to color ratio data of each of pixel points in each of the grid images, the electronic device is caused to:
label the color ratio data of each of pixel points in each of the grid images in a standard grey-band diagram, and filtering out abnormal color ratio data;
sequentially acquire grid images, in each of which the abnormal color ratio data is filtered out, as a target image; and
determine a white balance calibration parameter corresponding to the target image according to the number of target color ratio data in the target image,
wherein a color ratio data range corresponding to each of standard light sources is identified in the standard, grey-band diagram, and different standard light sources correspond to different white balance calibration parameters.
